(19) United States
(12) Patent Application Publication
(10) Pub. No.: US 2004/0213413 A1
(43) Pub. Date: Oct. 28, 2004

(54) Audio recording device for use with optical instruments

(75) Inventor: Christopher Douglas Blair, Lewes (GB)

Correspondence Address: Christopher Blair, Ivor Cottages, South Chailey, Lewes, East Sussex, BN8 4AP, GB

(73) Assignee: Software Hothouse Ltd., Burgess Hill (GB)

(21) Appl. No.: 10/834,400

(22) Filed: Apr. 28, 2004

(30) Foreign Application Priority Data
Apr. 28, 2003 (GB) GB 0309588.2

(51) Int. Cl. H04R 5/00

(52) U.S. Cl. 381/26

(57) ABSTRACT

The invention relates to an audio recording system designed for use in conjunction with an optical instrument—typically a pair of binoculars. By attaching the device to the binoculars and arranging the user controls and indicators so that the device may be operated whilst looking through the binoculars, naturalists and others are able to dictate their observations whilst watching their subject. By including a directional microphone, automatically aligned in the direction that the binoculars are pointing, the user can also record the sounds made by the subject being watched—again without taking their eyes off the subject. An associated software package uploads the recordings to a computer and facilitates the transcription and archiving of the recordings. Said software can also download audio recordings to the device allowing the user to play these for comparison with the sound made by the subject being watched.

### BACKGROUND OF THE INVENTION

The invention relates to an audio recording device and associated software specifically designed for use by naturalists and others who use binoculars or telescopes in the field and wish to record their observations. These recordings may include both the sounds generated by the subject being watched through the binoculars and the spoken notes made by the observer.

Handheld recorders designed for dictation of audio notes are well known. Recently, recorders have become smaller and lighter as the use of magnetic tape has been replaced by digital memory storage.

These dictation devices were primarily designed for use by office workers with at least one hand free to operate the controls and who are able view the indicators and/or visual display on the device. The replay mechanism for these is typically designed for a skilled typist and is intended to maximize the efficiency of transcription.

Naturalists, such as birdwatchers, often wish to take notes of their observations but are handicapped in using these audio devices as their hands are often occupied holding and focussing binoculars. In such cases it is difficult to continue to observe the subject through the binoculars whilst operating such a voice recorder at the same time.

A further disadvantage of standard dictation recorders is that their microphone is designed to pick up speech uttered within a few inches of the device. The sampling rate and compression techniques used are also suitable only for speech. Birdwatchers, in particular, would like to record the call or song of the bird they are watching yet most do not wish to invest in or carry the bulky directional microphones and recording equipment needed for high quality recording of birdsong.

### SUMMARY OF THE INVENTION

An object of this invention is to provide a sound recorder that is easily carried and used in conjunction with a pair of binoculars and that provides some degree of higher quality and directional recording capability. This latter feature allows the user to record the sounds made by the subject being watched in addition to recording utterances made by the user whilst watching said subject. When used with the accompanying software package, the overall system allows the user to take more extensive and immediate notes of his sightings, without taking his eye off the subject and subsequently to organise, catalogue and transcribe these notes.

### DESCRIPTION OF THE DRAWINGS

Accordingly, this invention provides a lightweight, battery-powered recording unit 1 designed to fit between and beneath the eye-pieces of a pair of binoculars in the orientation shown in FIGS. 5 and 6. Said unit includes two microphones (5,15) positioned respectively for (a) optimal recording of sound emanating from the direction in which the binoculars are pointed and (b) utterances made by the user of the binoculars. The controls therefore lie flat against the chest when the binoculars are not in use and the main recording control can be operated by the user's thumb when the binoculars are in use.

The recorder preferably contains two microphones. The first of these, 5, is oriented above the user's mouth when the binoculars are held to the eyes. The other, 15, a directional microphone, points forward in the direction the user is looking through the binoculars.

Control of the unit is deliberately much simpler than that on standard dictation units with a three-way switch, 9, controlling recording and a further three buttons 6,7,8 controlling replay. Whereas most dictation recorders typically use a small Liquid Crystal Display (LCD) to show the user information, this unit provides a simple capacity display 14, a battery level indicator 3 and recording status indicator 2.

Because of the need for silence when watching birds, a loudspeaker is not provided but a headphone socket 10 allows the user to play back audio to a separate earpiece.

Preferably, the device contains an attitude sensor (or “tilt-switch”) that can sense whether the unit is being held vertically or horizontally. A small buzzer is also contained within the unit so that, when held vertically it will “beep” occasionally if left recording for longer than a preset time. This ensures that the unit is not accidentally left recording for long periods of time.

Connection to a Personal Computer (PC), laptop computer or Personal Digital Assistant (PDA) is provided by means of a USB port 4, through which recordings may be transferred and other device characteristics controlled.

It will be appreciated that alternative means of communicating with other computing and communications devices may also be incorporated. For example, a Bluetooth or 802.11b or similar wireless interface would allow interaction with similarly equipped mobile phones, PDAs and laptops.

Optionally, the device may include a removable memory device, such as a Sony Memory Stick or Compact Flash allowing recordings to be physically transferred to another device and/or to allow the user to provide additional recording capacity through the purchase and use of additional such memory devices.

Obviously, such a device could easily be integrated within the overall construction of a pair of binoculars thus avoiding the need for a separate case and means of attachment. It can also be attached to and used in conjunction with a field telescope or even a microscope.

A preferred embodiment of the invention will now be described with reference to the accompanying drawing in which:

FIG. 1 shows the surface of the invention that is uppermost when attached to binoculars that are hanging vertically against the user's chest.

FIG. 2 shows the surface of the invention that is against the user's chest when attached to binoculars that are hanging vertically against said user's chest.

FIG. 3 shows the surface of the invention that is in contact with the binoculars.

FIG. 4 shows the surface of the invention that projects between the objective lenses of the binoculars.

FIG. 5 shows the view a user would have when holding a pair of binoculars, to which the invention is attached, up to his eyes.

FIG. 6 shows the view a user would have when holding a pair of binoculars, to which the invention is attached, vertically in front of him i.e. with the strap between binoculars and neck at 45 degrees.

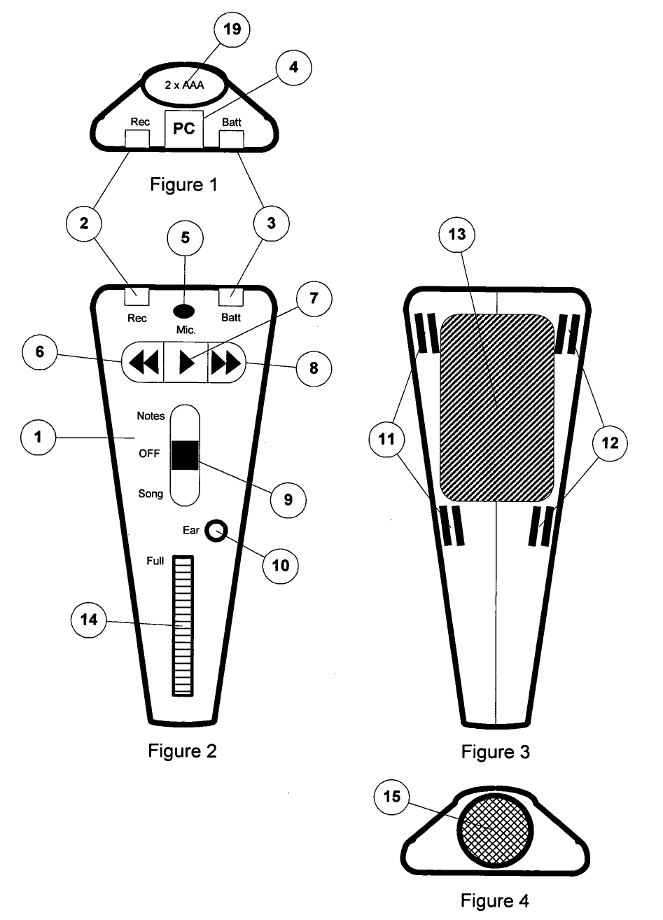

### DETAILED DESCRIPTION OF THE INVENTION

The device is battery-powered, with access to the 2×AAA batteries via the hinged cover 19 in the upper surface of the device. Internally, a low-power digital signal processor, such as those found in cellular telephones, controls the operation of the device and provides audio compression and decompression functions as well as interacting with the various switches and indicators described below. In addition to program memory, a large volume, typically 64 megabytes of non-volatile memory is built into the device in which to store audio recordings. A real-time clock is also included as are two microphones 5,15 and associated analogue amplification and analogue to digital conversion circuitry.

A mercury tilt-switch is built onto the main circuit board and the unit can therefore sense whether it is being held vertically (i.e. binoculars against the user's chest) or horizontally (i.e. binoculars in use). Changes in attitude are used to infer user activity whilst long periods of fixed attitude are used to infer that the unit is idle and will enter power-down mode—extinguishing the visual indicators until the unit is tilted or shaken again. This avoids the need for a dedicated power on/off control.

When vertical, if the unit is left recording for more than a minute, an audible “beep” will be generated from a tone generator on the circuit board to alert the user to this state. Thus the user will avoid accidentally leaving the unit recording for long periods.

The unit includes a Universal Serial Bus (USB) interface, the connector for which is protected by a rain-proof rubber flap 4. This interface is used to connect the unit, via an appropriate cable to a laptop computer, PC or PDA running the supplied control software. Using said software package, the user may:

Upload recordings made on the unit

Download recordings to the unit

Set the real-time clock

Set user preferences for recording mode, power-down timeout, replay duration, recording sample rates and compression ratios, recording left-on beep timer and interval

The user controls the unit by means of several buttons and switches. The three-way switch 9 is used to control recording—being either off (central position), via the microphone 5 for audio note-taking or via the directional microphone 15 for recording bird-song. The position of this switch allows the user to operate it with either thumb whilst using the binoculars, even if focusing using the focus control 16 with his index finger. The use of a slider switch allows the user to sense easily with his thumb which position the switch is in. Tactile feedback is provided on the central position allowing the user to feel positive feedback that the switch has been returned to the centre when wishes to stop recording.

When recording via the directional microphone, a higher quality recording is made than when taking notes. Typically a higher sample rate is used and a different compression scheme is used than for note taking. Typically a telephony grade compression scheme such as 8 kHz sampling and G.726 Adaptive Differential Pulse Code Modulation (ADPCM) is used for note taking whilst a music grade scheme such as MP3 is used for recording birdsong.

As recording starts, the current time is automatically noted against the recording. Recording continues until the button is returned to the central (off) position. Each such contiguous period of audio recorded is hereafter referred to as “a recording”.

Visual confirmation of the recording state is provided by the tri-colour Light Emitting Diode (LED) 2 which indicates Red, Green or Amber respectively for the recording states “Off”, “Notes” and “Song” just described. The position of this LED 2 is such that the user can see it clearly regardless of the orientation of the device. Even when the user's eyes are pressed against the eye-pieces 17,18 the user need only move their head back a few millimetres from the lenses to see the indicator out of the corner of their eye and confirm that recording is occurring. This avoids the need to take one's eyes off the subject completely—and risking losing track of it.

The multi-segment LED 14 shows the proportion of the unit's memory that has been used and hence how much is still available. The LEDs are typically green towards the bottom, amber in the centre and red towards the “Full” marker. To preserve power, these LEDs are extinguished after a pre-set time should no user activity occur.

The battery level is indicated by means of a tri-colour LED 3 which indicates good, low or very-low states by green, amber and red flashes respectively. To preserve power, the duty-cycle of this LED is a very short flash once a second.

The note-taking microphone 5 is a standard telephony grade microphone similar to those used in existing dictation recorders and cellular telephones and is positioned so as to be above the user's mouth when the binoculars are in use and can also be used when the binoculars are held vertically in front of the user's mouth. Automatic gain control is applied to this microphone so that the user need only whisper whilst recording notes.

The directional microphone 15 extends for much of the length of the device internally and provides a modest degree of directional gain allowing recording of birdsong emanating from the direction in which the binoculars are pointed. Additional gain may be provided by attaching a parabolic reflector to the end of the device. To avoid obstructing the user's view through the binoculars, such a reflector may be designed deliberately sub-optimally with the upper surface flattened so as to not to intrude on the field of view of the binoculars.

Replay is available only through a separate earphone connected via the socket 10. This earphone may optionally include, within its lead, an integral volume control. As recordings are stored in strict chronological order as they are made, a very simple replay interface is provided in which buttons 6,7 and 8 are used to request playback. These buttons are recessed to avoid accidental operation as the unit is pressed against the user's chest.

Simply pressing button 7 will result in the last few seconds (default 5 s) of audio recorded being played back. This is used to provide rapid confirmation that the unit is recording and—particularly when recording birdsong—to allow the user to determine whether the quality is acceptable or whether to try and improve on this with a further recording—for example, by getting closer to the subject.

Pressing button 7 again, whilst replay is in progress, will pause the replay at that point. Pressing button 6 will move the replay point to the beginning of the last recording and start playing it. Repeatedly pressing button 6 will move the replay point to the start of successively earlier recordings. Conversely, pressing button 8 will move the replay point to successively later recordings. Thus using buttons 6 and 8, any previous recording may be found and played. Use of the recording control, 9, will clear the current replay point.

Pressing and holding button 6 or 8 for more than a second results in the replay point moving the first or last recording respectively. An audible “beep” confirms this action. This is particularly useful when the recorder has had one or more pre-recorded snippets of birdsong downloaded to it. These recordings are treated as being “older” than the recordings made on the unit and hence appear as the first recordings in the unit. These downloaded recordings optionally include a spoken “title”—such as the name of the species whose song follows. When playing these recordings, the title is played once and the body of the recording is then repeated over and over until any button is pressed—stopping replay. This allows very efficient use of memory as only one call or cycle of the bird's song need be stored yet the user can listen to it several times through his earphone whilst comparing it with the song of the birds he is viewing. This mechanism also allows the user to skip through several such pre-recordings listening only to the title before pressing the “forward” 8 or “backwards” 6 button again until he hears the one he is looking for. As with recordings, the spoken titles are compressed using telephony grade sampling and compression whilst the actual birdsong is in a music quality storage format.

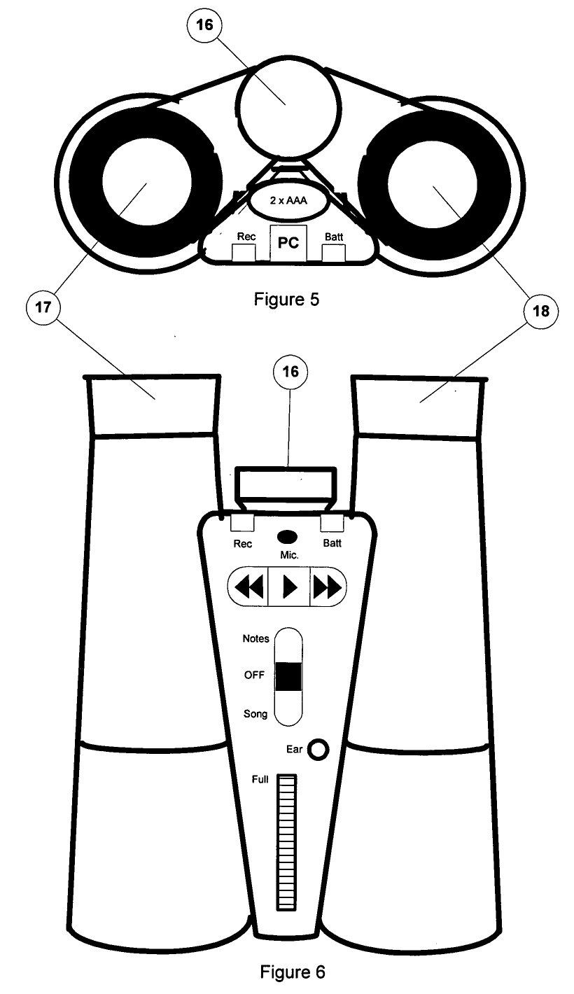

The unit is triangular in cross-section and tapered to fit between the eye-pieces of a pair of binoculars as shown in FIGS. 5 and 6. The face that is in contact with the binoculars provides several recessed strap guides 11, 12 through which narrow straps can be passed to allow the unit to be securely fastened to the binoculars. This mode of attachment is particularly suited to older style binoculars.

If used without binoculars, these same strap guides 11, 12 allow the unit to be hung around the neck using standard binocular or camera straps.

Alternatively, the user may choose to use self-adhesive Velcro (RTM) pads which can be stuck to the binoculars and will then grip the large, mating Velcro area 13. The pads need only make contact across a small proportion of the area 13 for a firm grip to be made. When attached in this way, the unit can easily be removed and used in the hand, transferred to another pair of binoculars or attached to a telescope—simply by the provision of additional Velcro (RTM) strips stuck to these other instruments.

1. An audio recording device designed for use with an optical instrument such as a pair of binoculars, including:
a) One or more microphones positioned and/or oriented so as to optimise recording of sound coming from the direction in which the binoculars are pointed
b) One or more microphones positioned and/or oriented so as to optimise recording of sound coming from the mouth of the user of the binoculars

2. A device as in claim 1 with means of starting and stopping recording via each microphone independently.

3. A device as in claim 2 in which said means of controlling recording are arranged so as to be operable without interfering with the normal use of the binoculars.

4. A device as in claim 1 in which the orientation of the device controls the recording automatically.

5. A device as in claim 1 in which the orientation of the device determines whether or not and how feedback is provided to the user regarding the state of the recording device.

6. A device as in claim 1 in which the physical outline of the device is such that it lies in the centre of a pair of binoculars and hence lies flush against the chest when said binoculars are not in use.

7. A device as in claim 6 in which the physical outline tapers linearly in two dimensions so that, by tilting the device at the appropriate angle, a linear rather than point contact is provided with the two halves of the binoculars across a range of angles between these two halves.

8. A device as in claim 1 in which the attachment to the optical instrument is easily released and reattached.

9. A device as in claim 1 which is incorporated within the overall casing and hence forms an integral part of the optical instrument.

10. A device as in claim 1 to which one or more pre-recorded audio segments may be downloaded and played under the control of the user such that when played, the downloaded audio segments are annotated by being pre-fixed with an audio description of the sounds that follow.

11. A device as in claim 1 in which a single audio processing circuit is shared between the two audio inputs.

12. A device as in claim 1 in which the audio processing automatically treats recordings from the two inputs differently.

13. An audio recording device substantially as herein described above and illustrated in the accompanying drawings.
